(19) United States
(12) Patent Application Publication
(10) Pub. No.: US 2004/0233483 A1
(43) Pub. Date: Nov. 25, 2004

(54) Film holder and image read controller

(76) Inventors: Eiichi Harada, Nagano (JP); Tetsuya Mizuno, Nagano (JP); Michiyoshi Takashima, Nagano (JP)

Correspondence Address: EDWARDS & ANGELL, LLP, P.O. BOX 55874, BOSTON, MA, 02205, US

(21) Appl. No.: 10/773,023

(22) Filed: Feb. 4, 2004

(30) Foreign Application Priority Data
Feb. 5, 2003 (JP) P2003-028854
Feb. 14, 2003 (JP) P2003-037447

(51) Int. Cl. H04N 1/10

(52) U.S. Cl. 358/487

(57) ABSTRACT

A film holder has a strip film holder provided at a position where when one corner of the film holder is matched with a corner of an original bed of the image reader having the same positional relationship as the corner, as many frames as a half the number of frames of one roll of strip film are contained in the read area; when a corner on the opposite side to the corner of the film holder in the longitudinal side direction is matched with a corner on the opposite side to the corner of the original bed of the image reader in the lateral side direction, other frames than the frames of the strip film are contained in the read area. Accordingly, worsening the operability in reading a transparency can be prevented in the image reader which has a read area meeting as many frames as a half the number of frames of one roll of strip film and can read a transparency.

### TECHNICAL FIELD

This invention relates to an image read controller for controlling a flatbed image reader that can read a transparency and a film holder for reading a transparency in a flatbed image reader.

### BACKGROUND ARTS

A flatbed image reader for operating a read mechanism for an original placed on an original bed to read data enters widespread use. The flatbed image reader includes a one-dimensional image pickup device (line sensor) as a read mechanism and reads reflected light from the original while moving (subscanning) a carriage on which the image pickup device and a light source are mounted relative to the original, thereby acquiring two-dimensional image information.

Since a transparency of a negative film, a positive film, or the like allows light to pass through, the flatbed image reader for reading reflected light is not fitted to reading the transparency.

Then, a flatbed image reader provided with another light source on a cover of an original bed to read transmitted light from a film for making it possible to also read a transparency is commercially practical.

FIG. 12 is a drawing to show the appearance of such a flatbed image reader.

As shown in the figure, a light source 115a provided on an original bed cover 115 is a surface light source for illuminating a part of an original bed, for example, a rectangular portion extending in the subscanning direction in the center (dashed-line area in FIG. 12) matching the size of a film. Since the portion becomes a read area, the flatbed image reader capable of reading a transparency uses a film holder as a guide for positioning the film to be read in the read area.

FIG. 13 is a drawing to show an outline of the appearance of a film holder in a related art. A film holder 150 in the related art includes a strip film holder section 151 forholding one roll of 35-mm strip film and a slide film holder section 152 for holding a maximum of four frames of mounted 35-mm film.

To read strip film, as shown in the figure, the film holder 150 is placed on the original bed with the upper-right corner of the film holder 150 matched with the upper-right corner of the original bed, whereby the strip film holder section 151 is positioned in the transparency read area indicated by the dashed line.

On the other hand, to read slide film, the film holder 150 is turned upside down and is placed on the original bed with the upper-right corner of the film holder 150 (the lower-left corner in FIG. 13) matched with the upper-right corner of the original bed, whereby the slide film holder section 152 is positioned in the transparency read area indicated by the dashed line, as shown in FIG. 14.

The image read processing of the image reader is separated into scanning processing of actual image read processing and prescanning processing of read processing of an outline of an original with the read resolution reduced. An image read controller such as a host computer for controlling the image reader previews the read image in the prescanning processing and accepts specification of the read range, setting of the read resolution, etc.

### DISCLOSURE OF THE INVENTION

In recent years, a model having a light source 125a which has a size reduced to a half that in the related art and is placed at the depth of an original bed cover 125 to reduce the cost of the image reader and because of limitations on design has been proposed as shown in FIG. 15.

In such a model, only three of six frames of strip film can be placed in the read area. Thus, to read the fourth to sixth frames, the strip film is mounted on the film holder so as to place the four to sixth frames in the read area as shown in FIG. 16; to read the first to three frames, the strip film is mounted on the film holder so as to place the first to three frames in the read area as shown in FIG. 17.

Therefore, to read one roll of strip film, mounting the strip film must be repeated and the load on the user is increased.

On the other hand, to read the first to third frames, the image read controller needs to preview the first to third frames in this order; to read the fourth to sixth frames, the image read controller needs to preview the fourth to sixth frames in this order.

However, the orientation of the strip film to read the first to third frames (see FIG. 17) and that to read the fourth to sixth frames (see FIG. 16) become reverse and thus the read order and the display order of the first to third frames and those of the fourth to sixth frames must be reversed. The direction for rotating 90 degrees to correct the top and bottom for the first to third frames and that for the fourth to sixth frames also become reverse.

However, whether the frames of strip film read in the prescanning are the first to third frames orthe fourth to sixth frames cannot be determined from the read images. Thus, a problem of the difficulty of previewing the frames of the strip film in the normal orientation in the order of the frames occurs.

It is a first object of the invention not to worsen operability in reading a transparency in an image reader which has a read area meeting as many frames as a half the number of frames of one roll of strip film and can read a transparency.

It is a second object of the invention to make it possible to recognize frames to be read in an image read controller for controlling an image reader which has a read area meeting as many frames as a half the number of frames of one roll of strip film and can read a transparency.

It is a third object of the invention to make it possible to preview frames of strip film in the normal orientation in the order of the frames in an image read controller for controlling an image reader which has a read area meeting as many frames as a half the number of frames of one roll of strip film and can read a transparency.

To the ends, according to a first aspect of the invention, there is provided a film holder to read a transparency with a flatbed image reader which has a read area meeting as many frames as a half the number of frames of one roll of strip film and can read a transparency, the film holder including:

a strip film holder mechanism for holding strip film,

the strip film holder mechanism being provided at a position where

when one corner of the film holder (corner H1) is matched with a corner of an original bed of the image reader having the same positional relationship as the corner H1 (corner B1), as many frames as a half the number of frames of one roll of strip film (first frame group) are contained in the read area;

when a corner (corner H2) on the opposite side to the corner (corner H1) of the film holder in the longitudinal side direction is matched with a corner (corner B2) on the opposite side to the corner (corner B1) of the original bed of the image reader in the lateral side direction, frames other than the first frame group of the strip film (second frame group) are contained in the read area.

Accordingly, as the film holder is turned upside down after the first frame group is read, the second frame group can be read, so that the need for again loading the film is eliminated and worsening the operability in reading a transparency can be prevented.

Here, the film holder can include:

two guide parts between the corner (corner H1) and the corner (corner H2) on the opposite side in the longitudinal side direction, wherein

the guide part to the corner (corner H1) can indicate the frames other than the first frame group of the strip film (second frame group) and the guide part to the corner (corner H2) on the opposite side in the longitudinal side direction can indicate the first frame group of the strip film.

Accordingly, it is made possible to associate the frames to be read and the film holder setting position with each other.

The film holder can further include:

a slide film holder mechanism for holding mounted slide film,

the slide film holder mechanism being provided at a position where

when a corner (corner H3) at a diagonal position to the one corner of the film holder (corner H1) is matched with the corner of the image reader (corner B1) or a corner (H4) on the opposite side to the one corner of the film holder (corner H1) in the lateral side direction is matched with the corner (corner B2) on the opposite side in the lateral side direction, the slide film is contained in the read area, whereby it is made possible for the image reader to read slide film.

At this time, the film holder can includes:

a guide part between the corner (corner H3) at the diagonal position and the corner (corner H4) on the opposite side in the lateral side direction, wherein

the guide part can indicate frames of the slide film.

To the ends, according to a second aspect of the invention, there is provided an image reader including a flatbed image reader main unit which has a read area meeting as many frames as a half the number of frames of one roll of strip film and can read a transparency, and a film holder to read a transparency with the flatbed image reader main unit, wherein

the film holder includes:

a strip film holder mechanism for holding strip film,

the strip film holder mechanism being provided at a position where

when one corner of the film holder (corner H1) is matched with a corner of an original bed of the image reader main unit having the same positional relationship as the corner H1 (corner B1), as many frames as a half the number of frames of one roll of strip film (first frame group) are contained in the read area;

when a corner (corner H2) on the opposite side to the corner (corner H1) of the film holder in the longitudinal side direction is matched with a corner (corner B2) on the opposite side to the corner (corner B1) of the original bed of the image reader main unit in the lateral side direction, frames other than the first frame group of the strip film (second frame group) are contained in the read area; and

two guide parts between the corner (corner H1) and the corner (corner H2) on the opposite side in the longitudinal side direction, wherein

the guide part to the corner (corner H1) indicates the frames other than the first frame group of the strip film (second frame group) and the guide part to the corner (corner H2) on the opposite side in the longitudinal side direction indicates the first frame group of the strip film, and wherein

the original bed of the image reader main unit is provided on a periphery with

a guide indication part for indicating the first frame group of the strip film at the position corresponding to the guide part to the corner (corner H2) when the corner of the film holder (corner H1) is matched with the corner (corner B1) of the original bed of the image reader main unit having the same positional relationship as the corner H1; and

a guide indication part for indicating the second frame group at the position corresponding to the guide part to the corner (corner H1) when the corner of the film holder (corner H2) is matched with the corner (corner B2) of the original bed of the image reader main unit.

Here, the film holder can further include:

a slide film holder mechanism for holding mounted slide film,

the slide film holder mechanism being provided at a position where when a corner (corner H3) at a diagonal position to the one corner of the film holder (corner H1) is matched with the corner of the image reader (corner B1) or a corner (H4) on the opposite side to the one corner of the film holder (corner H1) in the lateral side direction is matched with the corner (corner B2) on the opposite side in the lateral side direction, the slide film is contained in the read area; and

a guide part being provided between the corner (corner H3) at the diagonal position and the corner (corner H4) on the opposite side in the lateral side direction for indicating a frame of the slide film, and wherein

the original bed of the image reader main unit is provided on a periphery with

a guide indication part for indicating the frame of the slide film at the position corresponding to the guide part for indicating the frame of the slide film when the corner (corner H3) at the diagonal position to the one corner of the film holder (corner H1) is matched with the corner of the image reader (corner B1) or the corner (H4) on the opposite side to the one corner of the film holder (corner H1) in the lateral side direction is matched with the corner (corner B2) on the opposite side in the lateral side direction.

To the ends, according to a third aspect of the invention, there is provided a film holder to read a transparency with a flatbed image reader which has a read area meeting as many frames as a half the number of frames of one roll of strip film and can read a transparency, the film holder including:

a strip film holder mechanism for holding strip film and an identification hole,

the strip film holder mechanism being provided at a position where

when one corner of the film holder (corner H1) is matched with a corner of an original bed of the image reader having the same positional relationship as the corner H1 (corner B1), as many frames as a half the number of frames of one roll of strip film (first frame group) are contained in the read area;

when a corner (corner H2) on the opposite side to the corner (corner H1) of the film holder in the longitudinal side direction is matched with a corner (corner B2) on the opposite side to the corner (corner B1) of the original bed of the image reader in the lateral side direction, frames other than the first frame group of the strip film (second frame group) are contained in the read area,

the identification hole being provided

in the proximity of the strip film holder mechanism at a position contained in the read area when the one corner of the film holder (corner H1) is matched with the corner of the original bed of the image reader having the same positional relationship as the corner H1 (corner B1), or at a position contained in the read area when the corner (corner H2) on the opposite side to the corner (corner H1) of the film holder in the longitudinal side direction is matched with the corner (corner B2) on the opposite side to the corner (corner B1) of the original bed of the image reader in the lateral side direction.

The film holder is formed with the identification hole, whereby it is made possible for the image reader to recognize the frames to be read by recognizing the presence or absence of the identification hole.

To the ends, according to a fourth aspect of the invention, there is provided an image read controller for controlling a flatbed image reader which has a read area meeting as many frames as a half the number of frames of one roll of strip film and can read a transparency, the image read controller including:

determination means for determining whether or not an image of an identification hole exists at a point of an image of strip film read by the image reader corresponding to a predetermined position in the read area; and

preview means for previewing frames of the read strip film with the display order and the rotation direction of the frames changed in response to the determination result of the determination means.

The presence or absence of the identification hole is recognized and the preview mode is changed in response to the presence or absence of the identification hole, so that it is made possible to preview the frames of strip film in the normal orientation in the order of the frames.

Specifically, the preview means previews the frames with the frames rotated 90 degrees in the read order or with the frames rotated −90 degrees in the reverse order to the read order in response to the determination result of the determination means.

### BRIEF DESCRIPTION OF THE DRAWINGS

FIG. 1 is a block diagram to show the configuration of an image read system.

FIG. 2 is a block diagram to show the functional configuration of an image read control section.

FIG. 3 is a drawing to show the appearance of a film holder incorporating the invention.

FIG. 4 is a drawing to show the appearance of the peripheral portions of an original bed of an image reader incorporating the invention.

FIG. 5 is a drawing to show a state in which the first to three frames are read.

FIG. 6 is a drawing to show a state in which the fourth to sixth frames are read.

FIG. 7 is a drawing to show a state in which slide film is read.

FIG. 8 is a drawing to show preview processing of the first to third frames.

FIG. 9 is a drawing to show preview processing of the fourth to sixth frames.

FIG. 10 is a flowchart to describe preview processing.

FIG. 11 is a drawing to show another example of guide parts of the film holder.

FIG. 12 is a drawing to show an image reader in a related art.

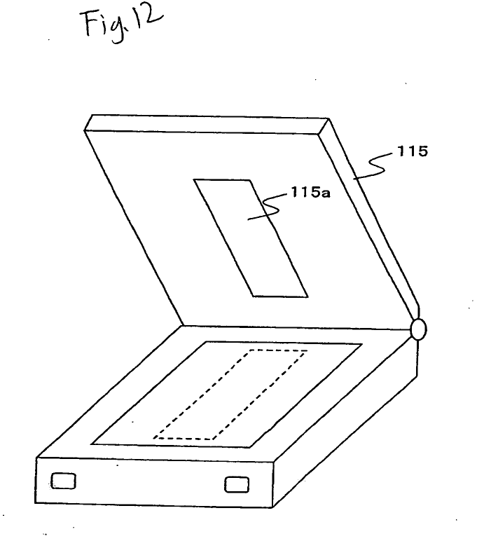

FIG. 13 is a drawing to show a film folder in a related art.

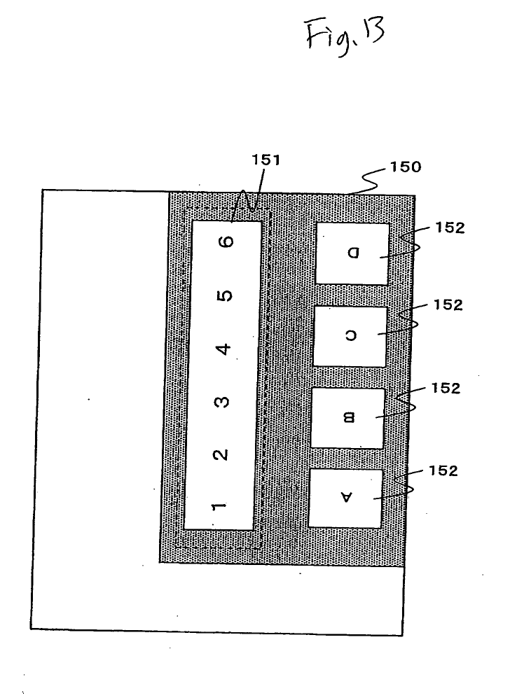

FIG. 14 is a drawing to show the film folder in the related art.

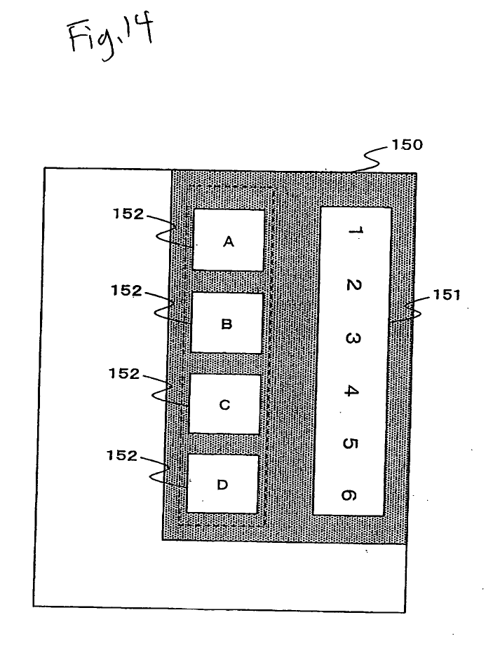

FIG. 15 is a drawing to show an image reader with a narrow image area of a transparency.

FIG. 16 is a drawing to show reading of fourth to sixth frames.

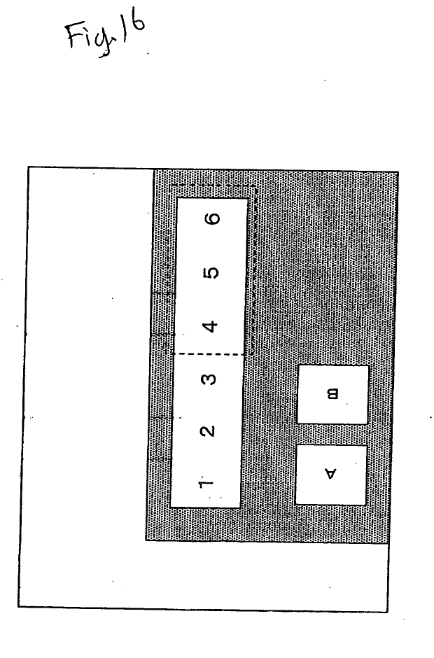

FIG. 17 is a drawing to show reading of first to third frames.

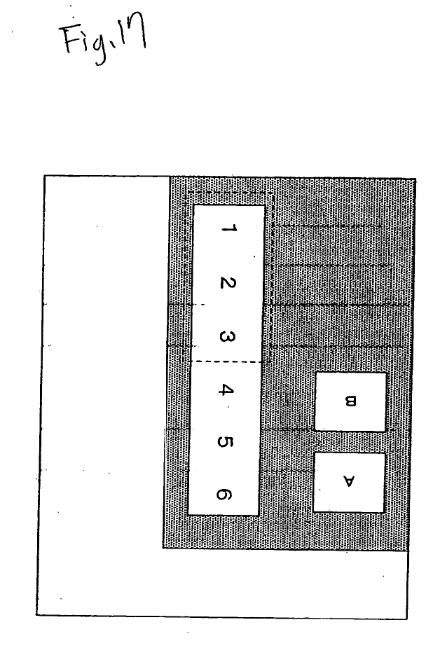

### BEST MODE FOR CARRYING OUT THE INVENTION

Referring now to the accompanying drawings, there is shown a preferred embodiment of the invention.

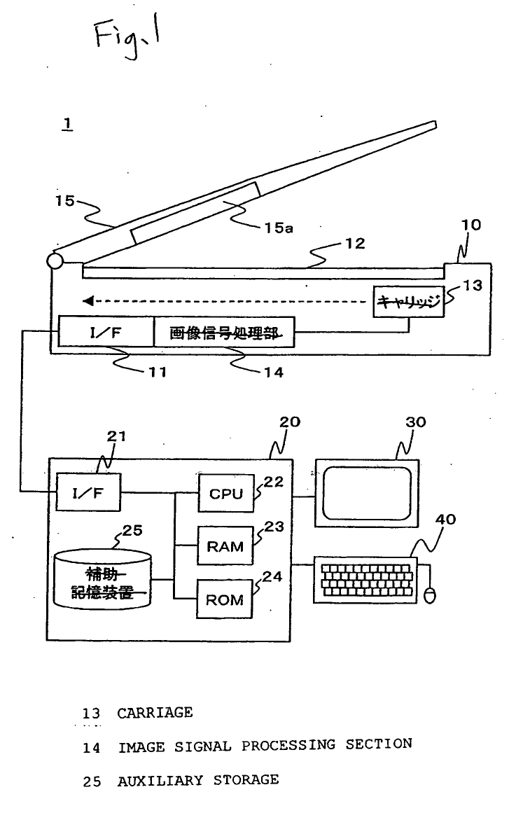

FIG. 1 is a block diagram to show the configuration of an image read system. As shown in the figure, an image read system 1 is made up of an image reader 10 and a host computer 20 for controlling the image reader 10 and performing image processing. The image reader 10 and the host computer 20 are connected via interfaces 11 and 21 for making it possible to conduct bidirectional communications with each other.

The image reader 10 is a flatbed image reader for reading a reflected original placed on an original bed, but also has a function to read a transparency as described later.

The image reader 10 includes a transparent original bed 12 to place an original on the top of a box-shaped cabinet, a carriage 13 for moving in the arrow direction in the figure (subscanning direction) for reading reflected light from the original placed on the original bed 12 while applying light to the original, an image processing section 14 for performing digital conversion of the reflected light signal read by the carriage 13 and performing processing of correction, etc., and then converting the signal into image data, and an original bed cover 15 to cover the original bed.

The carriage 13 includes a line light source, a reflecting mirror, a lens, and a line sensor and is reciprocated in the subscanning direction by a drive mechanism (not shown).

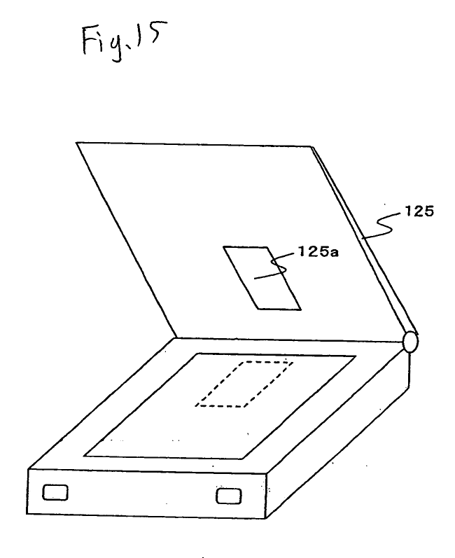

The original bed cover 15 is provided in a part (see FIG. 15) with a white surface light source 15a. As light is applied from the surface light source 15a, a transparencyof film, etc., placed on the original bed 12 can be read with the carriage 13. At this time, the film is placed on the original bed 12 with the film placed in a film holder so that the read section is fixed.

The host computer 20 can be implemented as a general-purpose personal computer including a CPU 22, RAM 23, ROM 24, auxiliary storage 25, etc. Amonitor 30 for displaying an image, an input unit 40 for accepting a command from the user, and the like are connected to the host computer 20.

A control program for the image reader is installed in the host computer 20. As the CPU 22 executes the program, an image read control section is constructed in the host computer and the host computer 20 functions as an image read controller.

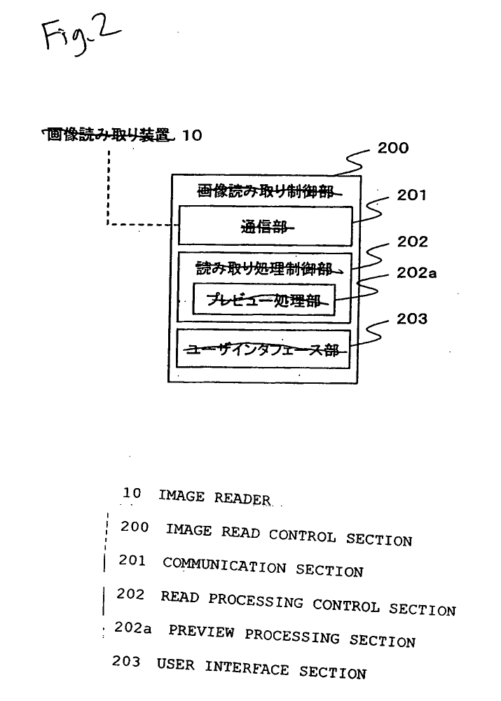

FIG. 2 is a block diagram to show the functional configuration of an image read control section 200 constructed in the host computer 20.

As shown in the figure, the image read control section 200 includes a communication section 201 for conducting communications with the image reader 10, a read processing control section 202 for controlling image read processing in the image reader 10, and a user interface section 203 for accepting a command from the user and presenting information concerning image read processing.

The image read processing in the image reader 10 is separated into scanning processing of actual image read processing and prescanning processing. The prescanning processing is read processing of an image of the original placed on the original bed 12 in a short time with the resolution reduced prior to the scanning processing. The read processing control section 202 previews the read image in the prescanning processing and accepts specification of the read range, setting of the read resolution, etc.

To perform the processing, the read processing control section 202 includes a preview processing section 202a for performing processing to preview the original image read in the prescanning processing.

If a transparency is to be read, the preview processing section 202a takes out frames the read film image and previews the frames.

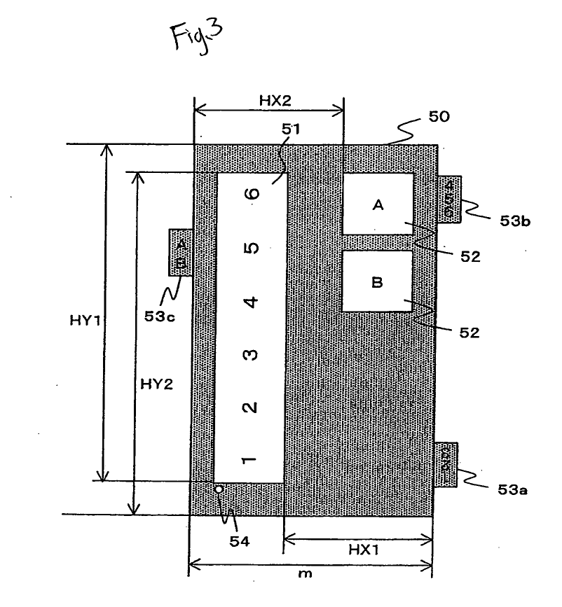

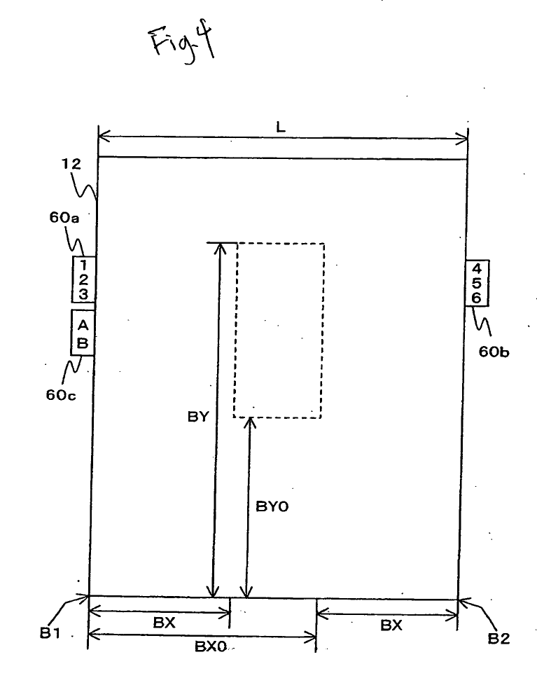

FIG. 3 is a drawing to show the appearance of a film holder 50 incorporating the invention. FIG. 4 is a drawing to show the appearance of the peripheral portions of the original bed 12 of the image reader 10 incorporating the invention. The film holder 50 usually is distributed as an attachment to the image reader 10.

As shown in FIG. 3, the film holder 50 includes a strip film holder 51 for holding one roll of strip film of six frames (first to sixth frames) and a slide film holder section 52 for holding a maximum of two frames of slide film (frames A and B). The film holder 50 has ameasure of thickness, for example, a thickness of about several millimeters to reliably hold film and provide strength and durability. Each of the film holder sections 51 and 52 is provided in a side margin with a film press mechanism for suppressing curling of film and preventing displacement of film

Guide parts 53a, 53b, and 53c as guides for placing the film holder on the original bed 12 are provided at three points of the margins of the film holder 50, and an identification hole 54 is made in the proximity of the strip film holder section 51. “123,” “456,” and “AB” are indicated on the guide parts 53a, 53b, and 53c respectively.

In the embodiment, “123” and “456” indicate the frame numbers of strip film and “AB” indicates the frames of slide film. Of course, the frame indication method is not limited to them.

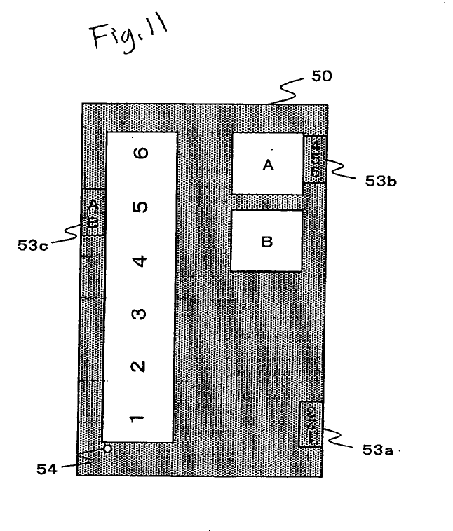

The guide parts 53 of the film holder 50 may be provided inside the film holder as shown in FIG. 11 rather than on the outside of the film holder like tabs as in FIG. 3.

The guide part 53a indicated as “123” is placed at a position to clarify the correspondence with the first to third frames, in the margin on the opposite side to the strip film holder section 51, and the guide part 53b indicated as “456” is placed at a position to clarify the correspondence with the fourth to sixth frames, in the margin on the opposite side to the strip film holder section 51. The guide part 53c indicated as “AB” is placed at a position to clarify the correspondence with the slide film holder section 52, in the margin on the opposite side to the slide film holder section 52.

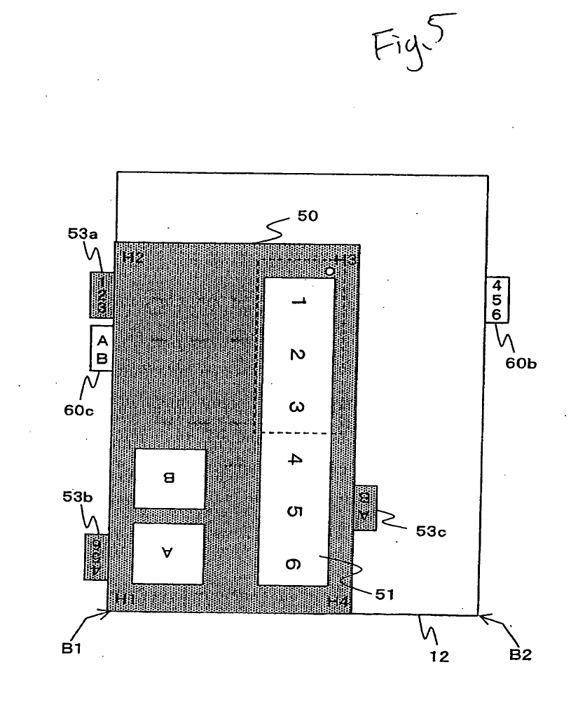

Guide indication parts 60a, 60b, and 60c as guides for placing the film holder 50 on the original bed 12 are provided at three points in the vicinity of the original bed 12 of the image reader 10. “123,” “456”, “AB” and are indicated on the guide indication parts 60a, 60b, and 60c respectively. The positions where the guide indication parts 60 are provided will be discussed with reference to FIGS. 5 to 7. The lower-left corner of the original bed 12 is B1 and the lower-right corner is B2.

The rectangle indicated by the dashed line in FIG. 4 is the light application range of the surface light source 15a and is the read area of a transparency in the image reader 10. The area is set a little larger than the size capable of reading three frames of strip film

FIG. 5 is a drawing to show a state in which the first to three frames of strip film of six frames are read using the film holder 50.

That is, the film holder 50 is turned upside down from the orientation shown in FIG. 3 and the lower-left corner of the film holder 50 (H1) is matched with the lower-left corner of the original bed 12 (B1), whereby the first to three frames of strip film are contained in the read area.

The guide indication part 60a indicated as “123” provided in the periphery of the original bed 12 is placed at a position to clarify the positional correspondence with the guide part 53a indicated as “123” provided on the film holder 50, for example, at the overlap position, the side-by-side position, or the like.

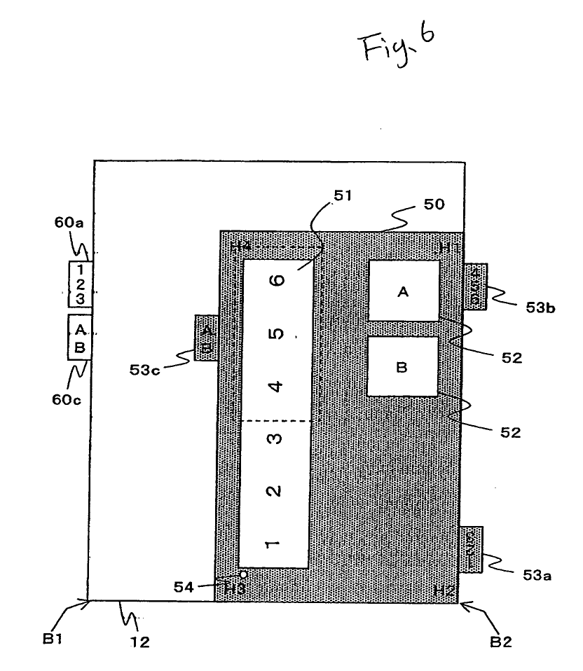

FIG. 6 is a drawing to show a state in which the fourth to sixth frames of strip film of six frames are read using the film holder 50.

That is, the lower-right corner of the film holder 50 (H2) is matched with the lower-right corner of the original bed 12 (B2) in the orientation shown in FIG. 3, whereby the fourth to sixth frames of strip film are contained in the read area.

The guide indication part 60b indicated as “456” provided in the periphery of the original bed 12 is placed at a position to clarify the positional correspondence with the guide part 53b indicated as “456” provided on the film holder 50, for example, at the overlap position, the side-by-side position, or the like.

The read face in FIG. 5 is the same as that in FIG. 6 and to turn the film holder 50 upside down, the film holder 50 in FIG. 3 is turned 180 degrees to that in FIG. 5.

Thus, the lower-left corner of the film holder 50 turned upside down (H1) is matched with the lower-left corner of the original bed 12 (B1), whereby the first to three frames of strip film are contained in the read area, and the lower-right corner of the film holder 50 (H2) is matched with the lower-right corner of the original bed 12 (B2), whereby the fourth to sixth frames of strip film are contained in the read area. To do this, the strip film holder section 51 of the film holder 50 is placed at the following position:

To begin with, as shown in FIG. 4, it is assumed that the transparency read area is provided at the position of BX from the left and right sides relative to the lateral side direction of the original bed 12 of lateral width L (namely, is positioned in the center relative to the lateral side direction) and in the range of the upper end of BY from the lower side to the lower end of BY0 from the lower side relative to the longitudinal side direction.

As shown in FIG. 3, letting the distance of the strip film holder section 51 from the far side relative to the lateral side direction of the film holder 50 be HX1 and the distances at both ends from far sides relative to the longitudinal side direction be HY1 and HY2, it is assumed that the relations BX=HX1 and BY=HYl=HY2 are almost satisfied. The reason why the relations “are almost satisfied” is that the transparency read area is set a little larger than the size of three frames of strip film. Thus, in fact, BX<HX1 and BY>HY1=HY2 (namely, the strip film holder section 51 is positioned in the center relative to the lateral side direction).

Letting the distance of the slide film holder section 52 from the far side relative to the lateral side direction of the film holder 50 be HX2, it is assumed that the relation BX=HX2 is almostsatisfiedsothat theslide film holdersection 52 is contained in the transparency read area at the slide film reading time.

More particularly, lateral width m of the film holder 50 satisfies (L/2<m) and the positions of (2m−L/2) from both sides of the film holder 50 become the center positions of the film holder sections 51 and 52 in the lateral direction thereof. In the longitudinal direction, the read area of the film holder section 51, 52 is contained in the range of BY to BY0.

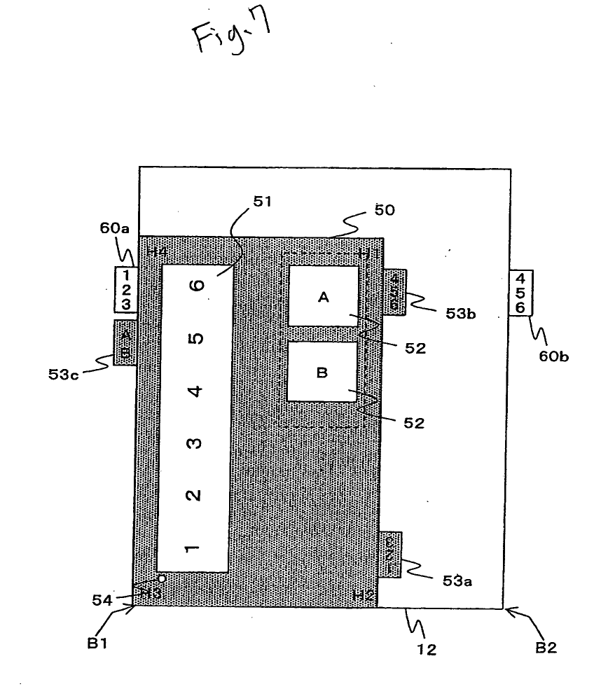

FIG. 7 is a drawing to show a state in which slide film is read using the film holder 50.

That is, in the orientation shown in FIG. 3, the lower-left corner of the film holder 50 (H3) is matched with the lower-left corner of the original bed 12 (B1), whereby frames A and B of slide film are contained in the read area. If the slide film holder section 52 is provided in the lower half of the film holder 50 on the drawing, the film holder 50 is turned upside down and the lower-right corner of the film holder 50 (H4) is matched with the lower-right corner of the original bed 12 (B2).

The guide indication part 60c indicated as “AB” provided in the periphery of the original bed 12 is placed at a position to clarify the positional correspondence with the guide part 53c indicated as “AB” provided on the film holder 50, for example, at the overlap position, the side-by-side position, or the like.

Next, preview processing of the preview processing section 202a of the read processing control section 202 in reading strip film in prescanning will be discussed.

Generally, each frame of strip film is horizontally oriented and the frames are arranged in order from left to right. Therefore, each frame of strip film read in the longitudinal direction with the film holder 50 needs to be rotated 90 degrees for previewing for the user to easily see the frames.

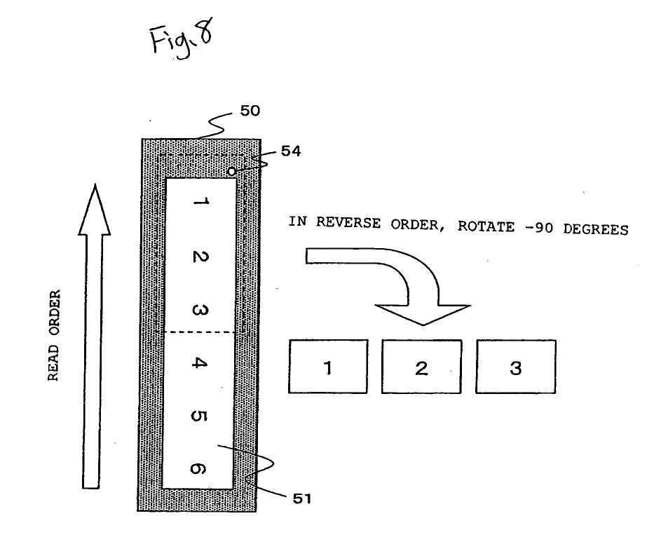

As shown in FIG. 8, to read the first to third frames of strip film, the images are read in the order of the third frame, the second frame, and the first frame because of the subscanning direction.

Thus, to read the first to third frames of strip film, the preview processing section 202a previews the frames in the reverse order to the read order with each frame rotated 90 degrees. If the subscanning direction or the strip film load direction is reverse, the read order and the image rotation direction become reverse, of course.

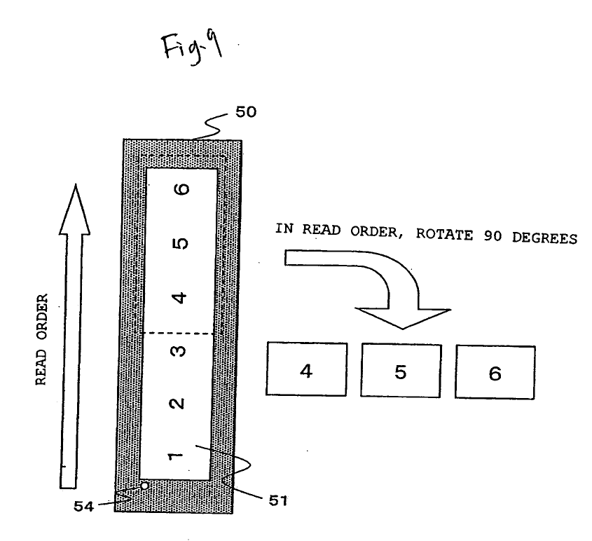

On the other hand, to read the fourth to sixth frames of strip film, the images are read in the order of the first frame, the second frame, and the third frame, as shown in FIG. 9.

Thus, to read the fourth to sixth frames of strip film, the preview processing section 202a previews the frames in the read order with each frame rotated 90 degrees. If the subscanning direction or the strip film load direction is reverse, the read order and the image rotation direction become reverse, of course.

However, the preview processing section 202a cannot determine whether the read frames are the first to third frames or the fourth to sixth frames from the read strip film images.

Then, in the embodiment, the identification hole 54 is made in the proximity of the strip film holder section 51 of the film holder 50. The identification hole 54 is provided at a position contained in the read area on the side of the first to third frames, for example. Since the identification hole 54 allows light to pass through, if the identification hole 54 is contained in the read area, it can be recognized from the read image.

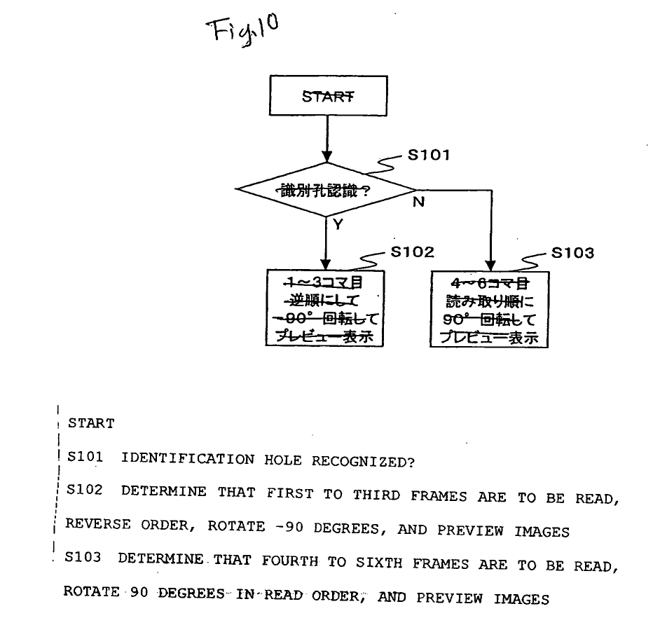

As shown in a flowchart of FIG. 10, if the identification hole 54 is recognized in the read image (YES at S101) in previewing of strip film, the preview processing section 202a determines that the first to third frames of the strip film are to be read, and then reverses the order of the read frame images, rotates the frame images −90 degrees, and previews the images (S102). In scanning, the frames may be read in the reverse order to the read order.

On the other hand, if the identification hole 54 is recognized in the read image (NO at S101), the preview processing section 202a determines that the fourth to sixth frames of the strip film are to be read, and then rotates the read frame images 90 degrees in the read order and previews the images (S103). In scanning, the frames may be read in the read order.

What is claimed is:

1. A film holder for reading a transparency with a flatbed image reader which has a read area meeting as many frames as a half the number of frames of one roll of strip film and can read a transparency, the film holder comprising:
a strip film holder mechanism for holding strip film,
wherein the strip film holder mechanism is provided at a position where
when one corner of the film holder (corner H1) is matched with a corner of an original bed of the image reader having the same positional relationship as the corner H1 (corner B1), as many frames as a half the number of frames of one roll of strip film (first frame group) are contained in the read area;
when a corner (corner H2) on the opposite side to the corner (corner H1) of the film holder in the longitudinal side direction is matched with a corner (corner B2) on the opposite side to the corner (corner B1) of the original bed of the image reader in the lateral side direction, frames other than the first frame group of the strip film (second frame group) are contained in the read area.

2. The film holder according to claim 1 comprising:
two guide parts between the corner (corner H1) and the corner (corner H2) on the opposite side in the longitudinal side direction, wherein
the guide part to the corner (corner H1) indicates the frames other than the first frame group of the strip film (second frame group) and the guide part to the corner (corner H2) on the opposite side in the longitudinal side direction indicates the first frame group of the strip film.

3. The film holder according to claim 1 or 2 further comprising:
a slide film holder mechanism for holding mounted slide film,
the slide film holder mechanism being provided at a position where
when a corner (corner H3) at a diagonal position to the one corner of the film holder (corner H1) is matched with the corner of the image reader (corner B1) or a corner (H4) on the opposite side to the one corner of the film holder (corner H1) in the lateral side direction is matched with the corner (corner B2) on the opposite side in the lateral side direction, the slide film is contained in the read area.

4. The film holder according to claim 3 comprising:
a guide part between the corner (corner H3) at the diagonal position and the corner (corner H4) on the opposite side in the lateral side direction, wherein
the guide part indicates frames of the slide film.

5. An image reader comprising a flatbed image reader main unit which has a read area meeting as many frames as a half the number of frames of one roll of strip film and can read a transparency, and a film holder to read a transparency with the flatbed image reader main unit, wherein
the film holder comprises:
a strip film holder mechanism for holding strip film, the strip film holder mechanism being provided at a position where
when one corner of the film holder (corner H1) is matched with a corner of an original bed of the image reader main unit having the same positional relationship as the corner H1 (corner B1), as many frames as a half the number of frames of one roll of strip film (first frame group) are contained in the read area;
when a corner (corner H2) on the opposite side to the corner (corner H1) of the film holder in the longitudinal side direction is matched with a corner (corner B2) on the opposite side to the corner (corner B1) of the original bed of the image reader main unit in the lateral side direction, frames other than the first frame group of the strip film (second frame group) are contained in the read area; and
two guide parts between the corner (corner H1) and the corner (corner H2) on the opposite side in the longitudinal side direction, wherein
the guide part to the corner (corner H1) indicates the frames other than the first frame group of the strip film (second frame group) and the guide part to the corner (corner H2) on the opposite side in the longitudinal side direction indicates the first frame group of the strip film, and wherein
the original bed of the image reader main unit is provided on a periphery with
a guide indication part for indicating the first frame group of the strip film at the position corresponding to the guide part to the corner (corner H2) when the corner of the film holder (corner H1) is matched with the corner (corner B1) of the original bed of the image reader main unit having the same positional relationship as the corner H1; and
a guide indication part for indicating the second frame group at the position corresponding to the guide part to the corner (corner H1) when the corner of the film holder (corner H2) is matched with the corner (corner B2) of the original bed of the image reader main unit.

6. The image reader according to claim 5 wherein the film holder further comprises:
a slide film holder mechanism for holding mounted slide film,
the slide film holder mechanism being provided at a position where when a corner (corner H3) at a diagonal position to the one corner of the film holder (corner H1) is matched with the corner of the image reader (corner B1) or a corner (H4) on the opposite side to the one corner of the film holder (corner H1) in the lateral side direction is matched with the corner (corner B2) on the opposite side in the lateral side direction, the slide film is contained in the read area; and
a guide part being provided between the corner (corner H3) at the diagonal position and the corner (corner H4) on the opposite side in the lateral side direction for indicating a frame of the slide film, and wherein
the original bed of the image reader main unit is provided on a periphery with
a guide indication part for indicating the frame of the slide film at the position corresponding to the guide part for indicating the frame of the slide film when the corner (corner H3) at the diagonal position to the one corner of the film holder (corner H1) is matched with the corner of the image reader (corner B1) or the corner (H4) on the opposite side to the one corner of the film holder (corner H1) in the lateral side direction is matched with the corner (corner B2) on the opposite side in the lateral side direction.

7. A film holder to read a transparency with a flatbed image reader which has a read area meeting as many frames as a half the number of frames of one roll of strip film and can read a transparency, the film holder comprising:
a strip film holder mechanism for holding strip film and an identification hole,
the strip film holder mechanism being provided at a position where
when one corner of the film holder (corner H1) is matched with acorner of an original bed of the image reader having the same positional relationship as the corner H1 (corner B1), as many frames as a half the number of frames of one roll of strip film (first frame group) are contained in the read area;
when a corner (corner H2) on the opposite side to the corner (corner H1) of the film holder in the longitudinal side direction is matched with a corner (corner B2) on the opposite side to the corner (corner B1) of the original bed of the image reader in the lateral side direction, frames other than the first frame group of the strip film (second frame group) are contained in the read area,
the identification hole being provided
in the proximity of the strip film holder mechanism
at a position contained in the read area when the one corner of the film holder (corner H1) is matched with the corner of the original bed of the image reader having the same positional relationship as the corner H1 (corner B1), or at a position contained in the read area when the corner (corner H2) on the opposite side to the corner (corner H1) of the film holder in the longitudinal side direction is matched with the corner (corner B2) on the opposite side to the corner (corner B1) of the original bed of the image reader in the lateral side direction.

8. An image read controller for controlling a flatbed image reader which has a read area meeting as many frames as a half the number of frames of one roll of strip film and can read a transparency, the image read controller comprising:
determination means for determining whether or not an image of an identification hole exists at a point of an image of strip film read by the image reader corresponding to a predetermined position in the read area; and
preview means for previewing frames of the read strip film with the display order and the rotation direction of the frames changed in response to the determination result of the determination means.

9. The image read controller according to claim 8 wherein the preview means previews the frames with the frames rotated 90 degrees in the read order or with the frames rotated −90 degrees in the reverse order to the read order in response to the determination result of the determination means.

10. A program for causing a computer to function as an image read controller for controlling a flatbed image reader which has a read area meeting as many frames as a half the number of frames of one roll of strip film and can read a transparency, the program causing the computer to execute:
determination processing for determining whether or not an image of an identification hole exists at a point of an image of strip film read by the image reader corresponding to a predetermined position in the read area; and
preview processing for previewing frames of the read strip film with the display order and the rotation direction of the frames changed in response to the determination result.
